(19) United States
(12) Patent Application Publication
(10) Pub. No.: US 2024/0135806 A1
(43) Pub. Date: Apr. 25, 2024

(54) OUTPUT DEVICE

(71) Applicant: TOYOTA JIDOSHA KABUSHIKI KAISHA, Toyota-shi (JP)

(72) Inventors: Shusuke YAMAMOTO, Tokyo (JP); Chikara OKAZAKI, Gotemba-shi (JP); Kohta WATATSU, Nagoya-shi (JP); Hideyuki TANAKA, Nisshin-shi (JP); Shinya MURASE, Nagoya-shi (JP); Yuki TATSUMOTO, Seto-shi (JP)

(73) Assignee: TOYOTA JIDOSHA KABUSHIKI KAISHA, Toyota-shi (JP)

(21) Appl. No.: 18/377,398

(22) Filed: Oct. 5, 2023

(30) Foreign Application Priority Data
Oct. 20, 2022 (JP) 2022-169506

(51) Int. Cl. G08G 1/01; G06V 20/13; G06V 20/54

(52) U.S. Cl. CPC G08G 1/0141; G06V 20/13; G06V 20/54; G08G 1/0133; G06V 2201/08

(57) ABSTRACT

An output device, including a processor is provided. The processor is configured to: receive information indicating a target site and a target day; acquire a satellite image of the target site captured on a day that is related to the target day; and output data indicating a congestion level on the target day, at the target site, the congestion level being predicted based on the satellite image.

### CROSS-REFERENCE TO RELATED APPLICATION

This application is based on and claims priority under 35 USC 119 from Japanese Patent Application No. 2022-169506 filed on Oct. 21, 2022, the disclosure of which is incorporated by reference herein.

### BACKGROUND

### Technical Field

The present disclosure relates to an output device.

### Related Art

Japanese Patent Application Laid-Open (JP-A) No. 2022-034358 discloses a congestion prediction device. This congestion prediction device acquires, from a first sensor, information relating to a flow of people prior to a prediction timepoint on a target day in a target area, and acquires, from a second sensor, information relating to a flow of people prior to the prediction time point on the target day at a facility in the vicinity of the target area. Further, the congestion prediction device, using at least this information, predicts the flow of people at the target area after a predetermined time from the prediction timepoint.

The congestion prediction device disclosed in JP-A No. 2022-034358 has the problem that it is not possible to comprehend the congestion level at a site at which a sensor is not installed.

### SUMMARY

The present disclosure has been made in consideration of the above facts, and an object thereof is to provide an output device capable of comprehending the congestion level at a point at which a sensor is not installed.

An output device according to a first aspect includes a receiving unit that receives a target site and a target day; an acquisition unit that acquires a satellite image of the target site captured on a day that is related to the target day; and an output unit that outputs a congestion level on the target day at the target site predicted based on the satellite image.

In the output device of the first aspect, a receiving unit receives a target site and a target day, an acquisition unit acquires a satellite image of the target site captured on a day that is related to the target day, and an output unit outputs a congestion level on the target day at the target site predicted based on the satellite image. According to the output device of the first aspect, the congestion level at a site at which a sensor is not installed can be comprehended.

An output device according to a second aspect is the output device of the first aspect, in which the output unit outputs the congestion level, which is predicted based on the satellite image, which is captured on a date on which at least one of a day of the week or a time period is the same as the target day.

According to the output device of the second aspect, compared to cases in which prediction is not performed based on a satellite image captured on a date on which at least one of a day of the week or a time period is the same as the target day, the predicted congestion level can be comprehended with high accuracy.

An output device according to a third aspect is the output device of the first aspect or the second aspect, in which the receiving unit further receives a target time, and the output unit outputs the congestion level at the target time, which is predicted based on the satellite image, which is captured in a time slot that is the same as the target time.

According to the output device of the third aspect, compared to cases in which the target time is not predicted based on satellite images captured during the same time slot as the target time, the predicted congestion level can be comprehended with high accuracy.

An output device according to a fourth aspect is the output device of any one of the first aspect to the third aspect, in which the output unit outputs the congestion level, which is predicted based on a vehicle captured in the satellite image.

According to the output device of the fourth aspect, vehicle congestion can be comprehended.

An output device according to a fifth aspect is the output device of any one of the first aspect to the fourth aspect, in which the output unit outputs a prompt to change at least one of the target site or the target day in a case in which the congestion level is equal to or higher than a predetermined threshold value.

According to the output device of the fifth aspect, by prompting a change in at least one of the target site or the target day, the congestion level can be derived from at least one of a site at which, or a date on which, the congestion level is less than a threshold value.

According to the present disclosure, the congestion level at a site at which a sensor is not installed can be comprehended.

### BRIEF DESCRIPTION OF THE DRAWINGS

FIG. 1 is a diagram illustrating an exemplary schematic configuration of an output system according to an exemplary embodiment.

FIG. 2 is a block diagram illustrating an exemplary hardware configuration of a user terminal according to an exemplary embodiment.

FIG. 3 is a block diagram illustrating an exemplary hardware configuration of a center server according to an exemplary embodiment.

FIG. 4 is a block diagram illustrating an exemplary functional configuration of a CPU in a center server according to an exemplary embodiment.

FIG. 5 is a flow chart illustrating an exemplary flow of output processing according to an exemplary embodiment.

### DETAILED DESCRIPTION

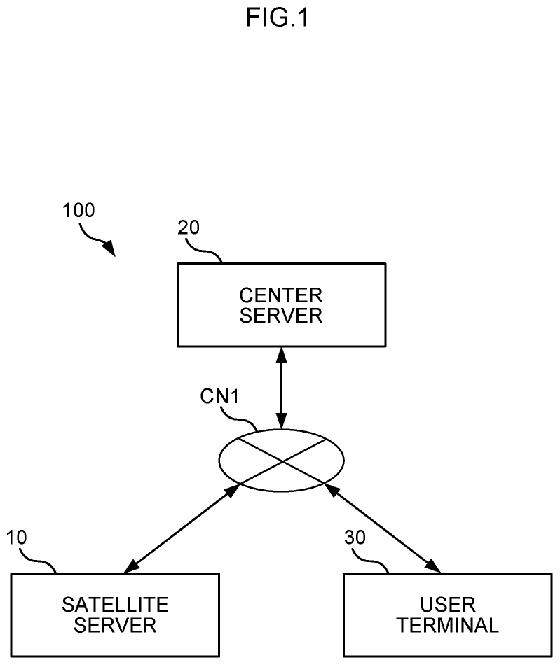

As illustrated in FIG. 1, an output system 100 of the present exemplary embodiment is configured including a satellite server 10, a center server 20, and a user terminal 30. The center server 20 is an example of an output device. Note that the number of user terminals 30 included in the output system 100 is not limited to the number illustrated in FIG. 1. The satellite server 10, the center server 20, and the user terminal 30 are connected together through a network CN1.

The satellite server 10 accumulates satellite images, these being terrestrial images captured from above by an artificial satellite, an aircraft, or the like. More specifically, the satellite server 10 stores satellite images in association with the date and time when the satellite image was captured, the day of the week when the satellite image was captured, and the site at which the satellite image was captured.

(User Terminal)

The user terminal 30 is a terminal such as a smartphone or a computer owned by a user.

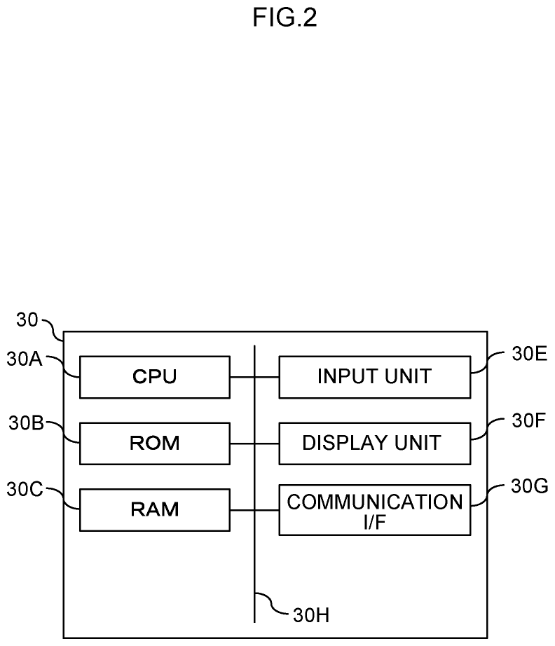

As illustrated in FIG. 2, the user terminal 30 is configured including a central processing unit (CPU) 30A, read only memory (ROM) 30B, random access memory (RAM) 30C, an input unit 30E, a display unit 30F, and a communication interface (I/F) 30G. The CPU 30A, the ROM 30B, the RAM 30C, the input unit 30E, the display unit 30F, and the communication I/F 30G are connected so as to be capable of communicating with each other through an internal bus 30H. Note that the user terminal 30 may include a non-volatile memory such as an SD card, in addition to the ROM 30B.

The CPU 30A executes various programs and controls various units. Namely, the CPU 30A, which is an example of a hardware processor, loads a program from the ROM 30B, which corresponds to a memory, and executes the program using the RAM 30C as a workspace.

The ROM 30B holds various programs and various data. The RAM 30C serves as a workspace to temporarily store programs and data.

The input unit 30E is, for example, a keyboard, a push-button ten-key pad, or a touch pad, and is used to input various information using a user's finger.

The display unit 30F is, for example, a liquid crystal display, and displays various information. The display unit 30F may be provided as a touch display also serving as the input unit 30E.

The communication I/F 20G is an interface for connecting to the network CN1.

(Center Server)

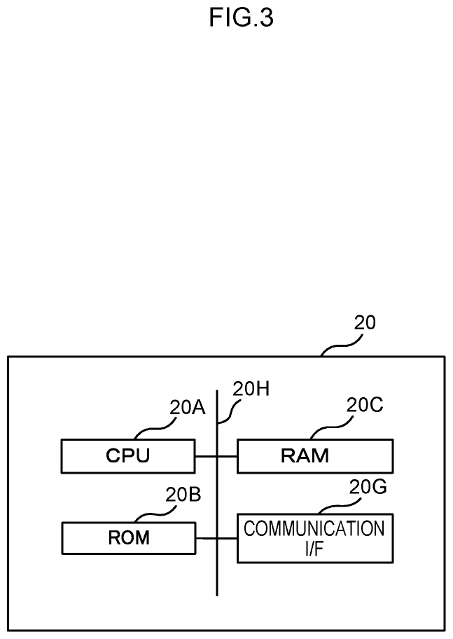

As illustrated in FIG. 3, the center server 20 is configured including a CPU 20A, a ROM 20B, a RAM 20C, and a communication I/F 20G. The CPU 20A, the ROM 20B, the RAM 20C, and the communication I/F 20G are connected so as to be capable of communicating with each other through an internal bus 20H.

The CPU 20A executes various programs and controls various units. Namely, the CPU 20A, which is an example of a hardware processor, loads a program from the ROM 20B, which corresponds to a memory, and executes the program using the RAM 20C as a workspace.

The ROM 20B holds various programs and various data. The RAM 20C serves as a workspace to temporarily store programs and data.

The ROM 20B of the present exemplary embodiment holds an output program.

The output program is a program for implementing various functionality possessed by the center server 20.

The communication I/F 20G is an interface for connecting to the network CN1.

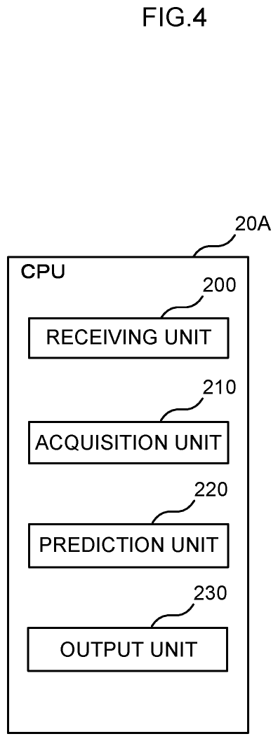

FIG. 4 is a block diagram illustrating an example of functional configuration of the CPU 20A. As illustrated in FIG. 4, the CPU 20A includes a receiving unit 200, an acquisition unit 210, a prediction unit 220, and an output unit 230. The respective functional configuration is implemented by the CPU 20A reading and executing an output program stored in the ROM 20B.

The receiving unit 200 has functionality to receive a target site and a target day. In the present exemplary embodiment, the receiving unit 200 receives the target site and the target day from the user terminal 30 via the communication I/F 20G.

The receiving unit 200 further has a function of receiving a target time. In the present exemplary embodiment, the receiving unit 200 receives the target time from the user terminal 30 via the communication I/F 20G.

The receiving unit 200 also receives a threshold value for the congestion level from the user terminal 30. The threshold value for the congestion level is a threshold value used to determine whether or not the output unit 230, described below, outputs a message prompting a change to at least one of the target site or the target day. However, there is no limitation to this example. For example, the receiving unit 200 may receive a threshold value for the congestion level from an administrator or the like at the center server 20.

The acquisition unit 210 has a function of acquiring a satellite image of a target site captured on a day related to the target day (hereafter also referred to simply as a “satellite image”). More specifically, the acquisition unit 210 acquires satellite images from the satellite server 10 via the communication I/F 20G.

In the present exemplary embodiment, the acquisition unit 210 acquires a satellite image of a target site captured on a date on which at least one of the day of the week, or the time period is the same as the target day. The time period is, for example, one week before and after the same day and month as the target day. For example, in a case in which the target day is Aug. 15, 2023 (Tuesday), the acquisition unit 210 acquires at least one of a satellite image captured on a Tuesday or a satellite image captured from Aug. 8, 2022, to Aug. 22, 2022. Note that the time period may be two weeks before and after the same day as the target day, or one month or the like. In addition, whether the acquisition unit 210 acquires a satellite image recorded on a date that is one of a date on which the target day and the day of the week are the same, a date on which the target day and the time period are the same, or a date on which the target day, the day of the week, and the time period are the same, may be predetermined by the user terminal 30, or may be predetermined by an administrator or the like of the center server 20.

The acquisition unit 210 may acquire a satellite image of a target site captured on a date on which at least one of the occurrence or absence of a holiday or the time period are the same as the target day. The occurrence or absence of a holiday means whether or not the day is a Saturday, a Sunday, or a national holiday. For example, in a case in which the target day is Aug. 15, 2023 (Tuesday), the target day is not a holiday. Accordingly, the acquisition unit 210 acquires at least one of satellite images taken on Monday, Tuesday, Wednesday, Thursday, or Friday, these being weekdays, and satellite images taken from Aug. 8, 2022, to Aug. 22, 2022.

In a case in which the receiving unit 200 has further received the target time, the acquisition unit 210 acquires satellite images captured during the same time slot as the target time received by the receiving unit 200. The time slot is, for example, 30 minutes before and after the target time received by the receiving unit 200. For example, in a case in which the target time is 13:00, the acquisition unit 210 acquires satellite images captured from 12:30 to 13:30. Note that the time slot may be one hour before or after the target time received by the receiving unit 200, or three hours before or after the target time or the like.

In the present exemplary embodiment, the acquisition unit 210 transmits the target site, the target day, and the target time received by the receiving unit 200 to the satellite server 10. Moreover, the satellite server 10 sends a satellite image of the target site captured during the same time slot as the target time on a date on which at least one of the day of the week or the time period is the same as the target day, to the center server 20. As a result, the acquisition unit 210 acquires a satellite image of the target site captured during the same time slot as the target time on a date on which at least one of the day of the week or the time period is the same as the target day.

Based on the satellite image acquired by the acquisition unit 210, the prediction unit 220 predicts the congestion level at the target site on the target day (hereafter simply referred to as the “congestion level”). In the present exemplary embodiment, the prediction unit 220 predicts the congestion level based on the vehicles captured in the acquired satellite image. More specifically, the prediction unit 220 predicts an average value of the number of vehicles present in the acquired satellite image as the congestion level. Note that the prediction unit 220 may predict an average value of a ratio of an area of vehicles parked in a parking lot to an area of the parking lot captured in the acquired satellite image as the congestion level. Moreover, the prediction unit 220 may predict the congestion level by inputting the satellite image acquired by the acquisition unit 210 into a congestion level prediction model that has learned by using, as data sets, the actual number of visitors to the target site or the number of vehicles actually parked in the parking lot at the target site, and the satellite image.

Moreover, in a case in which a group of persons is present in the satellite image acquired by the acquisition unit 210, the prediction unit 220 may output the area covered by the group of persons as the congestion level. In addition to the acquired satellite image, the prediction unit 220 may predict the congestion level based on position information of plural user terminals 30 on a date on which at least one of the day of the week or the time period is the same as the target day.

The output unit 230 has a function of outputting the congestion level on the target day at the target site predicted based on the satellite image. In the present exemplary embodiment, the output unit 230 outputs a congestion level estimated based on a satellite image captured on a date on which at least one of the day of the week or the time period is the same as the target day. Moreover, the output unit 230 outputs a congestion level at a target time estimated based on a satellite image captured during the same time slot as the target time. Moreover, the output unit 230 outputs a congestion level predicted based on vehicles appearing in the satellite image. Namely, the output unit 230 outputs the congestion level predicted by the prediction unit 220. In the present exemplary embodiment, the output unit 230 outputs the congestion level to the user terminal 30.

Moreover, the output unit 230 has a function of outputting a prompt to change at least one of the target site or the target day in a case in which the congestion level is equal to or greater than a threshold value. Note that in a case in which the congestion level is equal to or greater than the threshold value, a target day on which the congestion level is predicted to be less than the threshold value at the target site may be output. Moreover, in a case in which the congestion level is equal to or greater than the threshold value, the output unit 230 may output a target site at which the congestion level is predicted to be less than the threshold value on the target day.

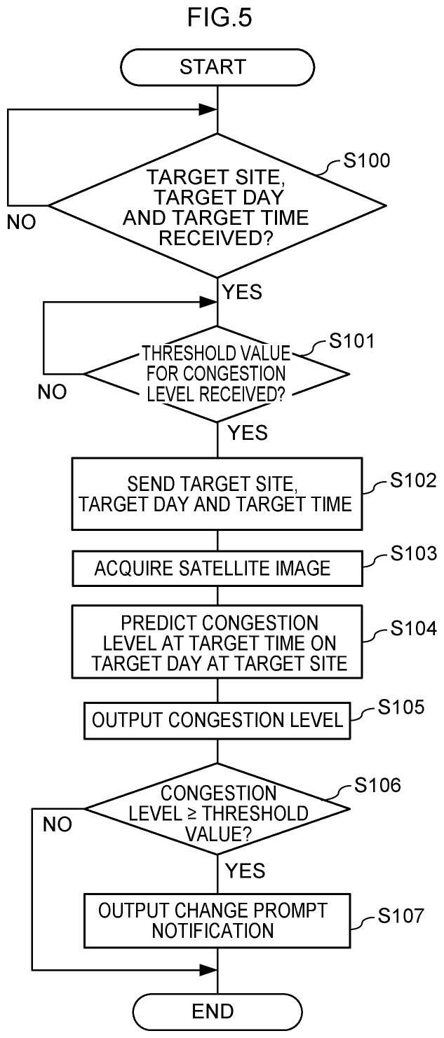

Next, explanation follows regarding a flow of output processing for outputting the congestion level, with reference to FIG. 5. The output processing is performed by the CPU 20A reading an output program from the ROM 20B, and expanding and executing the output program in the RAM 20C.

At step S100 in FIG. 5, the CPU 20A waits until it receives from the user terminal 30 the target site, the target day, and the target time. Upon receiving the target site, the target day, and the target time (step S100: YES), the CPU 20A transitions to step S101.

At step S101, the CPU 20A waits until a threshold value of the congestion level is received from the user terminal 30. When the CPU 20A receives the threshold value of the congestion level (step S101: YES), the processing transitions to step S102.

At step S102, the CPU 20A transmits the target site, the target day, and the target time received at step S100 to the satellite server 10.

At step S103, the CPU 20A acquires satellite images from the satellite server 10. More specifically, the CPU 20A acquires a satellite image of the target site captured during the same time period as the received target time on a date on which at least one of the day of the week or the time period is the same as the target day received at step S100.

At step S104, the CPU 20A predicts the congestion level at the target time on the target day at the target site. More specifically, the CPU 20A estimates the number of vehicles present in the satellite image acquired at step S103 as the congestion level.

At step S105, the CPU 20A outputs the congestion level predicted at step S104 to the user terminal 30.

At step S106, the CPU 20A determines whether or not the congestion level predicted at step S104 is greater than or equal to the threshold value received at step S101. In a case in which the predicted congestion level is equal to or greater than the received threshold value (step S106: YES), the CPU 20A transitions to step S107. On the other hand, in a case in which the predicted congestion level is less than the received threshold value (step S106: NO), the CPU 20A ends the present output processing.

At step S107, the CPU 20A outputs a change prompt notification to the user terminal 30, and ends the present output processing. More specifically, the CPU 20A outputs, to the user terminal 30, a prompt to change at least one of the target site or the target day, and ends the present output processing.

[Notes]

Note that in the above exemplary embodiments, a center server 20 configured separately from the user terminal 30 is applied as the output device. However, there is no limitation to this example. A device built into the user terminal 30 may be applied as an output device.

Moreover, in the above exemplary embodiments, satellite images are accumulated in the satellite server 10 configured separately from the center server 20. However, there is no limitation to this example. The satellite images may be stored in a storage device such as the ROM 20B or storage included in the center server 20.

Moreover, in the above exemplary embodiments, the center server 20 predicts the congestion level. However, there is no limitation to this example. Devices other than the center server 20 may predict the congestion level. In this case, the center server 20 outputs the congestion level predicted by a device other than the center server 20.

Note that the processing executed by the CPU reading and executing software (a program) in the above exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing described above may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although explanation has been given regarding an aspect in which the respective programs are stored (installed) in advance in the ROM in the above exemplary embodiments, there is no limitation thereto. The program may be provided in a format recorded on a recording medium such as compact disc read only memory (CD-ROM), digital versatile disc read only memory (DVD-ROM), or universal serial bus (USB) memory. Alternatively, the programs may be provided in a format downloadable from an external device over a network.

The flow of processing described in the above exemplary embodiments is also an example, and unnecessary steps may be deleted, new steps may be added, or the processing order may be rearranged within a range not departing from the spirit of the present invention.

The respective configurations of the satellite server 10, the center server 20, and the user terminal 30 described in the above exemplary embodiments are examples, and may be modified according to circumstances within a range not departing from the spirit of the present invention.

What is claimed is:

1. An output device, comprising a processor, the processor being configured to:
receive information indicating a target site and a target day;
acquire a satellite image of the target site captured on a day that is related to the target day; and
output data indicating a congestion level on the target day, at the target site, the congestion level being predicted based on the satellite image.

2. The output device of claim 1, wherein the satellite image is a satellite image captured on a date on which at least one of a day of the week or a time period is the same as the target day.

3. The output device of claim 1, wherein the processor is configured to:
receive information indicating a target time; and
output data indicating the congestion level at the target time, the congestion level being predicted based on the satellite image, which is captured in a time slot that is the same as the target time.

4. The output device of claim 1, wherein the congestion level is predicted based on a vehicle captured in the satellite image.

5. The output device of claim 1, wherein the processor is configured to output a prompt to change at least one of the target site or the target day in a case in which the congestion level is equal to or higher than a predetermined threshold value.
